(19) United States
(12) Patent Application Publication
(10) Pub. No.: US 2018/0355774 A1
(43) Pub. Date: Dec. 13, 2018

(54) METHOD FOR REGENERATING A PARTICLE FILTER IN THE EXHAUST SYSTEM OF AN INTERNAL COMBUSTION ENGINE, AND INTERNAL COMBUSTION ENGINE

(71) Applicant: Volkswagen Aktiengesellschaft, Wolfsburg (DE)

(72) Inventor: David SUDSCHAJEW, Abbesbuttel (DE)

(73) Assignee: Volkswagen Aktiengesellschaft, Wolfsburg (DE)

(21) Appl. No.: 15/988,400

(22) Filed: May 24, 2018

(30) Foreign Application Priority Data
Jun. 8, 2017 (DE) 10 2017 209 693.4

(51) Int. Cl. F01N 3/023; F02P 9/00; F02P 15/08; F01N 3/10; F02D 41/02; F01N 9/00; F01N 13/00; F01N 3/035

(52) U.S. Cl. CPC F01N 3/023; F02P 9/002; F02P 15/08; F01N 3/101; F01N 2430/08; F01N 9/002; F01N 13/009; F01N 3/035; F01N 2430/06; F02D 41/029

(57) ABSTRACT

A method for regenerating a particulate filter in an exhaust system of an internal combustion engine. In a normal operation, the internal combustion engine is operated at a stoichiometric air/fuel ratio. To regenerate the particulate filter, it is provided that the air/fuel ratio be adjusted toward lean, and, at the same time, that the combustion in the combustion chambers of the internal combustion engine be stabilized by suitably adapting the ignition energy, the duration of ignition, and/or the ignition frequency, to prevent misfires and the associated uncontrolled entrainment of unburned fuel into the exhaust system. The inventive method for regenerating the particulate filter makes possible a more rapid and lower-emission regeneration of a particulate filter. Also, an internal combustion engine having an exhaust system and a control unit that is adapted for implementing a method according to the present invention.

### FIELD OF THE INVENTION

The present invention relates to a method for regenerating a particulate filter in the exhaust duct of an internal combustion engine and to an internal combustion engine having an exhaust gas treatment system in accordance with the definition of the species set forth in the independent claims.

### BACKGROUND OF THE INVENTION

To meet the increasingly stringent demands of exhaust emissions legislation, vehicle manufacturers are taking appropriate measures to reduce untreated engine emissions and are providing suitable exhaust-gas treatments. With the introduction of the EU6 stage legislation for gasoline engines, a limit value for a particle count has been mandated that, in many cases, necessitates the use of a gasoline particulate filter. Such soot particles form, in particular, following a cold start of the internal combustion engine due to an incomplete combustion in combination with a leaner than stoichiometric air/fuel ratio, as well as cold cylinder walls during the cold start. The cold-start phase is, therefore, relevant to compliance with the mandatory particle count. Such a gasoline particulate filter also becomes further saturated with soot during vehicle operation. To prevent a sharp increase in the exhaust gas back pressure, this gasoline particulate filter must be continuously or periodically regenerated. The rise in the exhaust back pressure can lead to an excess consumption of the internal combustion engine, a power loss, a degradation of running smoothness, and even to misfires. Thermally oxidizing the soot trapped in the gasoline particulate filter requires a high enough temperature level in conjunction with the simultaneous presence of oxygen in the exhaust system of the gasoline engine. In this regard, additional measures are needed since today's gasoline engines are normally operated without excess oxygen at a stoichiometric air/fuel ratio (λ=1). Possible measures include increasing the temperature by adjusting the ignition timing, temporarily adjusting the gasoline engine toward lean, injecting secondary air into the exhaust system, for example, or a combination thereof. Until now, an ignition-timing retard has preferably been used in combination with a lean adjustment of the gasoline engine. This is because such a method does not require additional components, and a sufficient quantity of oxygen is able to be supplied in most operating points of the gasoline engine.

Cyclical misfires can thereby result due to the lean-combustion operation of the internal combustion engine in combination with internal-engine heating measures. In those approaches, unburned fuel arrives in the exhaust system and can thus damage the particulate filter or a catalytically active coating thereof. Furthermore, it takes a relatively long time to regenerate the particulate filter. This is because the air/fuel ratio is set to include only a small amount of excess air that is limited by the lean-mixture drivability of the internal combustion engine. The result is that the internal combustion engine must be operated for an extended period of time at a leaner than stoichiometric air/fuel ratio in order to completely regenerate the particulate filter. This causes the nitrogen oxide emissions to rise since a reducing agent for reducing nitrogen oxides is missing in the exhaust gas in a leaner than stoichiometric operation.

In the case of an internal combustion engine having a secondary air system, it is known to regenerate the particulate filter by a richer than stoichiometric operation of the internal combustion engine in combination with the introduction of secondary air into the exhaust duct. To that end, the particulate filter is configured downstream of a three-way catalytic converter, the secondary air being introduced into the exhaust duct downstream of the three-way catalytic converter and upstream of the particulate filter. In the process, the three-way catalytic converter is traversed by the flow of richer than stoichiometric exhaust gas, so that a rich breakthrough through the three-way catalytic converter occurs. At the surface of the particulate filter, this richer than stoichiometric exhaust gas is exothermically reacted with the oxygen from the introduction of secondary air and used for heating the particulate filter. If the particulate filter reaches the regeneration temperature for oxidizing the soot trapped in the particulate filter, the internal combustion engine is operated at a stoichiometric air/fuel ratio, and the soot trapped in the particulate filter is reacted exothermically with the secondary air. The emissions of unburned hydrocarbons (HC) and carbon monoxide (CO) thereby increase due to the richer than stoichiometric operation of the internal combustion engine, while there are no problems associated with increased nitrogen oxide emissions (NOx) in this method.

However, the disadvantage of such a method is that most motor vehicles do not have a secondary air system, thus precluding an implementation of the described method. Therefore, the particulate filter can only be regenerated by a leaner than stoichiometric operation of the internal combustion engine.

However, the disadvantage of the known methods for regenerating the particulate filter is that the particulate filter cannot be regenerated in an emissions-neutral way, the regeneration takes a relatively long time since the lean-mixture drivability of the engine is limited by a maximum air/fuel ratio of approximately λ=1.06, and cyclical misfires have to be taken into account, especially when a heating of the particulate filter is combined with a lean-combustion operation. Moreover, at times, a lean-combustion operation at low partial load is not at all possible due to misfire difficulties. Poor fuel quality can even worsen engine smoothness difficulties associated with lean-combustion operation and/or with increased exhaust gas back pressure. Also not possible is regenerating a four-way catalytic converter as a first component downstream of an exhaust of the internal combustion engine in an emissions-neutral way.

It is alternatively known to (partially) regenerate the particulate filter by trailing throttle fuel cutoff. However, this cannot be scheduled and is largely dependent on the driving profile of the driver and the area where the motor vehicle is operated. Moreover, a longer-lasting trailing-throttle phase can lead to an uncontrolled soot burn-off and thus thermally damage the particulate filter, particularly when the particulate filter is already hot.

Related art methods are also known that make it possible to stabilize the engine operation of an internal combustion engine during a lean-combustion operation. The German Patent Application 10 2010 008 013 A1 describes a system and a method for operating a multicylinder internal combustion engine. In this instance, the internal combustion engine has at least one spark plug at each of the combustion chambers thereof, the ignition energy and/or the ignition number per combustion cycle being adapted when an ionization detection signal associated with the respective cylinder of the internal combustion engine indicates a misfiring. However, this system and the method implemented therewith are relatively complex and cost-intensive since an additional sensor is required for each cylinder to acquire the ionization detection signal.

The German Patent Application DE 10 2014 015 486 A1 discusses a method for the mode- and map-dependent, switchable spark band ignition. It is intended that a multiple-spark ignition be made possible, the various ignition requirements being directly output to the ignition coil by a set of parameters stored in the engine control unit. This eliminates the need for an additional and complex ignition control unit, and the electronics on the ignition coil can be designed at a relatively low cost.

### SUMMARY OF THE INVENTION

It is, therefore, an object of the present invention to provide a rapid and low emission regeneration of a particulate filter and to overcome the disadvantages known from the related art.

This objective is achieved in accordance with the present invention by a method for regenerating a particulate filter or a four-way catalytic converter in an exhaust system of a spark-ignition internal combustion engine, that includes the following steps: operating the internal combustion engine at a stoichiometric air/fuel ratio (λ=1), the exhaust gas of the internal combustion engine being directed through the exhaust system, and the soot particulate contained in the exhaust gas separating out at the surface of the particulate filter or of the four-way catalytic converter; initiating a regeneration of the particulate filter or of the four-way catalytic converter when the particulate filter has reached or exceeded a stipulated saturation condition; regenerating the particulate filter or the four-way catalytic converter, the internal combustion engine being operated at a leaner than stoichiometric air/fuel ratio (λ>1) and, at the same time, the ignition energy, the duration of ignition, and/or the number of ignitions per combustion cycle being increased to ensure an ignition of the leaner than stoichiometric air/fuel ratio in the combustion chambers of the internal combustion engine.

The inventive method makes it possible for the particulate filter or the four-way catalytic converter to be regenerated at higher levels of excess air, making it possible to more rapidly complete the regeneration of the particulate filter. In addition, higher levels of excess air result in a reduction in untreated emissions during combustion, especially in the untreated emissions of nitrogen oxides since, along with the excess air, the combustion temperature decreases and thus fewer thermally induced nitrogen oxides form during combustion of the combustion air mixture in the combustion chambers of the internal combustion engine. By simultaneously increasing the ignition energy, the duration of ignition, and/or the number of ignition sparks per combustion cycle, the combustion at the leaner than stoichiometric air/fuel ratio is stabilized, so that misfires do not occur. This prevents unburned fuel from arriving in the exhaust duct and resulting in damage to the exhaust-gas treatment components there. The smoothness of the internal combustion engine is also enhanced, thereby allowing regeneration of the particulate filter to be essentially unnoticed by the driver of the motor vehicle. A regeneration of the particulate filter or of the four-way catalytic converter is also made possible even in the case of a low-load operation of the internal combustion engine, where a regeneration would not be possible without adapting the ignition energy, the duration of ignition, or the number of ignitions.

Advantageous improvements to and refinements of the method indicated in the independent claim for regenerating a particulate filter are made possible by the features delineated in the dependent claims.

A preferred specific embodiment of the method provides that a multiple-spark ignition be used to ignite the combustion air mixture during regeneration of the particulate filter or of the four-way catalytic converter. A multiple-spark ignition increases the likelihood of the ignition spark hitting an ignitable combustion air mixture and being able to ignite the same. The plurality of ignition sparks of the multiple-spark ignition may thereby occur simultaneously and, preferably, also in a staggered order. To be more precise, the likelihood increases of a secondary spark igniting an ignitable combustion air mixture in the combustion chamber of the internal combustion that was not ignited by the main spark of a spark plug. In the process, the point in time of the main ignition spark does not change, so that, in the normal operation of the internal combustion engine, the secondary spark is emitted at a point in time subsequent to the ignition spark.

A preferred specific embodiment of the method provides that the multiple-spark ignition take place in the form of a spark band ignition. In a spark band ignition, two or more ignition sparks may be produced relatively simply by one spark plug in a combustion cycle of the respective combustion chamber of the internal combustion engine. In a spark band ignition, a plurality of ignition sparks may be emitted within a brief period of time, i.e., within a combustion cycle per combustion chamber. The spark rate is thereby a function of the speed of the internal combustion engine, since the number of possible ignition sparks per combustion cycle drops with increasing speed. A spark band ignition stabilizes the smoothness of the internal combustion engine and prevents misfires during lean-combustion operation when the particulate filter or the four-way catalytic converter is regenerated. Alternatively, a multiple-spark ignition may also be realized by a corona ignition or a laser ignition. However, spark band ignition provides by far the most cost-effective multiple-spark ignition approach. Moreover, a high number of ignition sparks in a spark band ignition makes possible a further enleanment of the combustion air ratio, whereby the regeneration processes may again be accelerated, and the untreated emissions further reduced.

A preferred embodiment of the method provides that the leaner than stoichiometric air/fuel ratio be selected during regeneration of the particulate filter to be greater than 1.06, preferably greater than 1.1, especially within a range of between 1.1 and 1.25. While the lean-mixture drivability of the internal combustion engine is limited during normal operation of the internal combustion engine and a simple ignition, and misfires may occur already at an air/fuel ratio of λ=1.06, the lean-mixture drivability of the internal combustion engine is enhanced in a way that makes possible a further enleanment of the air/fuel ratio by raising the ignition energy, prolonging the duration of ignition and/or increasing the number of ignition sparks. An air/fuel ratio of 1.1<λ<1.25 is especially advantageous for actively regenerating the particulate filter or the four-way catalytic converter since this range combines several advantages. On the one hand, the regeneration period and the untreated emissions of the internal combustion engine may be reduced, as described. On the other hand, the risk of an uncontrolled soot burn-off on the particulate filter is diminished, since the burn-off rate of the soot remains limited by the moderate excess oxygen.

A preferred embodiment of the method provides that the ignition energy, the duration of ignition, and/or the number of ignitions be reduced again following the complete regeneration of the particulate filter or of the four-way catalytic converter. In this way, the method only very slightly increases wear to the ignition device, especially to the spark plugs, so that the service life of the ignition components essentially remains unchanged, and there is no need for more frequent service to change the spark plugs.

A preferred specific embodiment of the method provides that regeneration of the particulate filter or of the four-way catalytic converter be initiated at a degree of saturation of 2,500 mg soot or more. The number of necessary regeneration cycles for regenerating the particulate filter or the four-way catalytic converter thereby remains limited, so that such a regeneration is only rarely necessary during vehicle operation. This makes it possible to limit the extent to which fuel economy is reduced or comfort is lost in terms of running smoothness during regeneration of the particulate filter or of the four-way catalytic converter.

Another preferred specific embodiment of the method provides that an opening angle of a throttle valve in an air supply system of the internal combustion engine be enlarged to regenerate the particulate filter or the four-way catalytic converter. This makes possible an increased dethrottling of the internal combustion engine during regeneration of the particulate filter or of the four-way catalytic converter, thereby not only shortening the regeneration period, but also decreasing the fuel consumption.

A further enhancement of the method provides that a heating phase take place ahead of the regeneration phase of the particulate filter or of the four-way catalytic converter, the combustion air mixture being ignited during the heating phase; the duration of ignition, ignition energy, and the number of ignitions being that of normal operation. The higher conversion rates during particulate filter regeneration make it possible to shorten the heating phase, and no or only a few heating phases need to be interposed to heat the particulate filter, especially during the regeneration thereof. This makes it possible to reduce the fuel consumption of the internal combustion engine during regeneration of the particulate filter or of the four-way catalytic converter.

An alternative specific embodiment of the method provides that the ignition energy, duration of ignition or the number of ignitions be increased by a laser ignition. If the internal combustion engine is spark ignited by a laser ignition instead of by spark plugs, the energy introduced by the laser ignition may be alternatively increased during regeneration of the particulate filter or of the four-way catalytic converter to make possible a further enleanment of the combustion air mixture.

In addition, another alternative specific embodiment of the method provides that a corona ignition be used to increase the ignition energy, the duration of ignition or the number of ignitions. If the internal combustion engine is spark ignited by a corona ignition instead of by spark plugs, the energy introduced by the corona ignition may be alternatively increased during regeneration of the particulate filter or of the four-way catalytic converter to make possible a further enleanment of the combustion air mixture.

The present invention provides an internal combustion engine having at least one combustion chamber and at least one ignition element configured at the combustion chamber for externally supplying ignition to a combustion air mixture introduced into the at least one combustion chamber, and having an exhaust system that is coupled to an exhaust of the internal combustion engine, at least one particulate filter and one three-way catalytic converter or a four-way catalytic converter being configured in the exhaust system, the internal combustion engine having a control unit that is adapted for implementing a method according to the present invention when a machine-readable program code is executed on the control unit.

Unless indicated otherwise in the individual case, the various specific embodiments of the present invention mentioned in this application may be advantageously combined with one another.

### BRIEF DESCRIPTION OF THE DRAWINGS

The present invention will be explained in the following in light of exemplary embodiments and with reference to the accompanying drawings. Identical components or components having the same function are thereby characterized by the same reference numerals in the various figures, where:

FIG. 1 shows a first exemplary embodiment of an internal combustion engine having an exhaust gas treatment system in which a particulate filter may be regenerated by a method according to the present invention for regenerating the same;

FIG. 2 shows another exemplary embodiment of an internal combustion engine having an exhaust gas treatment system for regenerating a particulate filter in accordance with the present invention;

FIG. 3 shows another exemplary embodiment of an internal combustion engine having an exhaust gas treatment system for regenerating a particulate filter in accordance with the present invention;

FIG. 4 shows a diagram for regenerating a particulate filter in accordance with the present invention; and

FIG. 5 shows a diagram where the nitrogen oxide emissions in the case of an inventive method for regenerating a particulate filter in comparison to the nitrogen oxide emissions in a conventional regeneration of the particulate filter are represented by a leaner than stoichiometric air/fuel ratio.

### DETAILED DESCRIPTION OF THE INVENTION

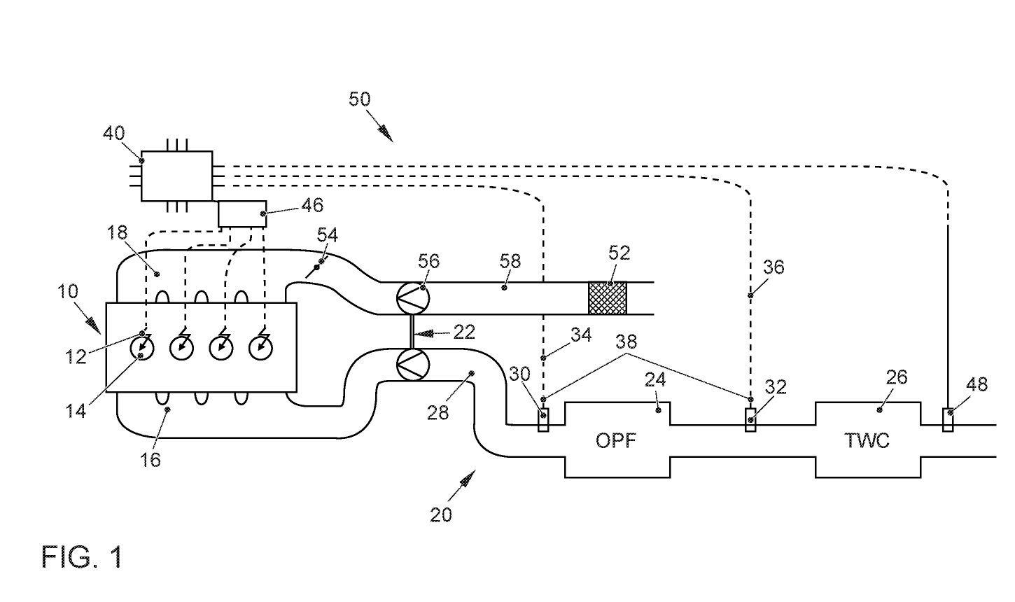

FIG. 1 shows a schematic representation of an internal combustion engine 10 whose exhaust 16 is coupled to an exhaust system 20. internal combustion engine 10 is designed as a spark ignition engine that is spark ignited by spark plugs 12 and has a plurality of combustion chambers 14. Internal combustion engine 10 is preferably designed as an internal combustion engine 10 that is charged by an exhaust-gas turbocharger 22, exhaust-gas turbocharger 22 being configured downstream of exhaust 16 and upstream of first emission-reducing exhaust treatment component 24, 26, 44. Exhaust system 20 includes an exhaust duct 28 in which a particulate filter 24 is disposed in the direction of flow of an exhaust gas through exhaust duct 28, as is a three-way catalytic converter 26 downstream of particulate filter 24. Particulate filter 24 and three-way catalytic converter 26 are thereby each preferably disposed close to the engine, i.e., at a distance of less than 80 cm exhaust gas flow length, more specifically of less than 50 cm exhaust gas flow length, from exhaust 16 of internal combustion engine 10. Further catalytic converters, especially an additional three-way catalytic converter, an NOx storage catalytic converter or a catalytic converter for selectively catalytically reducing nitrogen oxides may also be disposed in exhaust system 20. Located upstream of particulate filter 24 in exhaust duct 28 is a first lambda probe 30 for determining oxygen concentration λ₁ of the exhaust gas downstream of exhaust 16 and upstream of the first exhaust gas treatment component, thus particulate filter 24. Located downstream of particulate filter 24 and upstream of three-way catalytic converter 26 in exhaust duct 28 is a second lambda probe 32 for determining oxygen concentration λ₂ in exhaust duct 28 downstream of particulate filter 24 and upstream of three-way catalytic converter 26. First lambda probe 30 communicates via a first signal line 34 with a control unit 40 of internal combustion engine 10. Second lambda probe 32 communicates via a second signal line 36 with control unit 40. In this context, first lambda probe 34 [(sic.) 30] is preferably designed as a broadband lambda probe. Second lambda probe 32 is thereby preferably designed as a two-point lambda probe. First lambda probe 30 and second lambda probe 32 thereby form a sensor assembly 38 for regulating air/fuel ratio λ of internal combustion engine 10. An NOx sensor 48 may also be disposed in exhaust system 20 to determine the nitrogen oxide emissions and to ensure an in-vehicle diagnosis of exhaust gas treatment components 24, 26, 44. Particulate filter 24 may have an oxygen storage capacity OSC_{P}, charging oxygen accumulator OSC delaying the start of oxidation of the soot trapped in particulate filter 24.

In addition, internal combustion engine 10 has an intake 18 that is coupled to an air supply system 50 thereof. Air supply system 50 has a fresh-air duct 58 in which an air filter 52 is disposed. Configured downstream of air filter 52 is a compressor 56 of exhaust-gas turbocharger 22 that is used to compress the fresh air in order to better charge combustion chambers 14. Configured downstream of compressor 56 and upstream of intake 18 of internal combustion engine 10 in fresh-air duct 58 is a throttle valve 54 for controlling the volume of fresh air supplied to internal combustion engine 10. An ignition distributor 46 for controlling spark plugs 12 is provided that makes possible a spark band ignition of spark plugs 12.

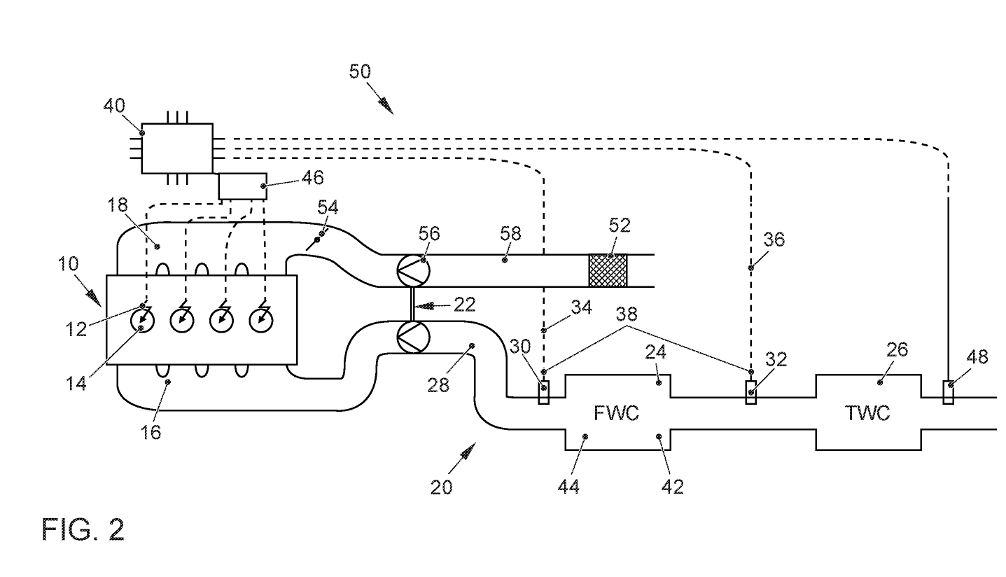

Another exemplary embodiment of an internal combustion engine having an exhaust gas treatment system is shown in FIG. 2. Particulate filter 24, configured to have essentially the same structure as in FIG. 1, additionally features a catalytically active noble metal coating 42, especially a coating 42 of platinum, palladium or rhodium and is designed as a four-way catalytic converter 44. Besides the catalytic function in the exhaust-gas treatment, catalytically active coating 42 may also be used for heating the particulate filter when unburned fuel components and residual oxygen react exothermically at this coating 42. The heating of particulate filter 24 to a regeneration temperature T_{reg} may be supported in this way. Four-way catalytic converter 44 features an oxygen storage capacity OSC_{FWC}, oxygen accumulator OSC of four-way catalytic converter 44 initially absorbing excess oxygen from the exhaust gas of internal combustion engine 10. If oxygen accumulator OSC is essentially completely charged, then the excess oxygen may be used for oxidizing the soot trapped in four-way catalytic converter 44.

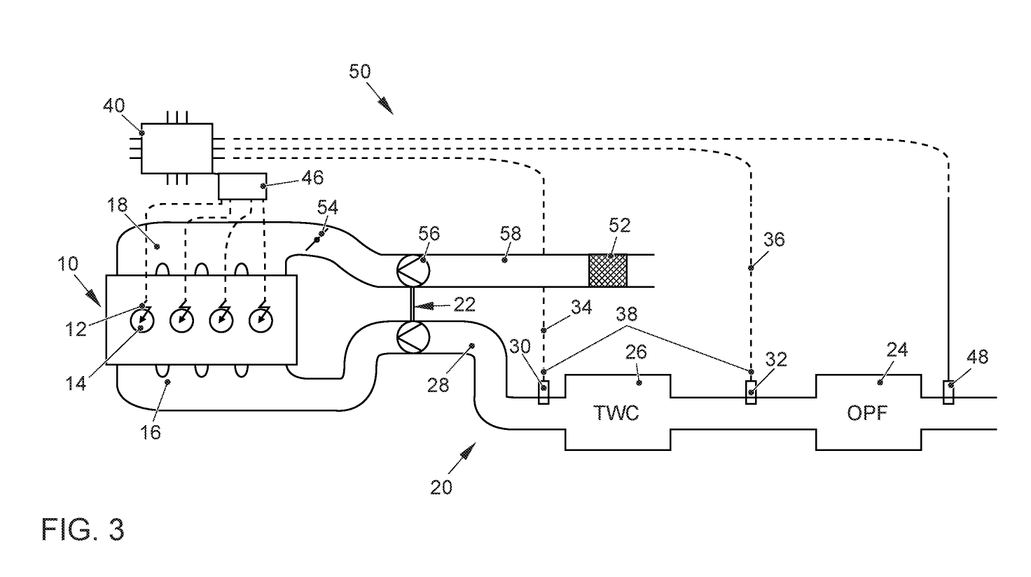

Another exemplary embodiment of an internal combustion engine having an exhaust gas treatment system is shown in FIG. 3. Three-way catalytic converter 26, configured to have essentially the same structure as in FIG. 1, is configured as the first component of exhaust-gas treatment downstream of exhaust 16 of internal combustion engine 10, and particulate filter 24 [is configured] downstream of three-way catalytic converter 26. Particulate filter 24 may be configured as an uncoated particulate filter or as a four-way catalytic converter 44 having a three-way catalytically active coating 42.

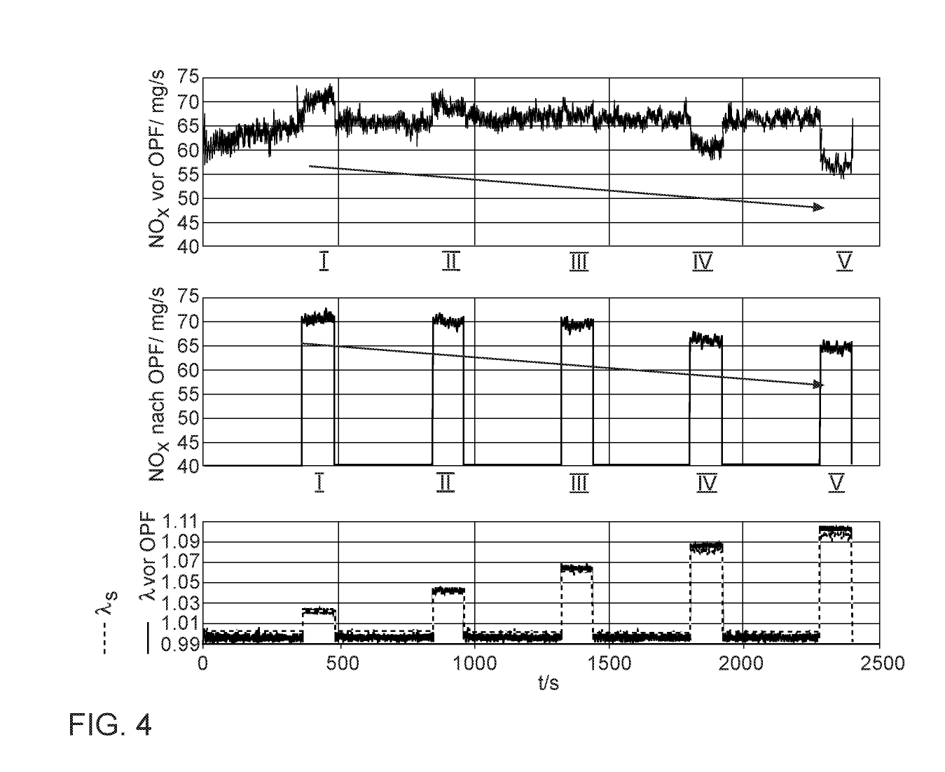

FIG. 4 illustrates the advantages of an inventive method for regenerating a particulate filter 24 or a four-way catalytic converter 44 in comparison to a conventional regeneration of particulate filter 24 or of four-way catalytic converter 44 using a (slightly) leaner than stoichiometric air/fuel ratio, as is known from the related art. In this instance, five different regeneration cycles I-V of a particulate filter 24 or of four-way catalytic converter 44, as well as the nitrogen oxide emissions prior to and subsequent to gasoline particulate filter OPF are plotted over time t. The excess oxygen of the air/fuel ratio thereby increases from first regeneration cycle I to fifth regeneration cycle V. The lowermost representation in FIG. 4 shows the setpoint value of air/fuel ratio λ_{S}, as well as air/fuel ratio λ_{priortoOPF} actually measured at first lambda probe 30 upstream of particulate filter 24 or four-way catalytic converter 44. First regeneration I of particulate filter 24 or of four-way catalytic converter 44 is carried out at a lambda value of about 1.02; second regeneration II at a lambda value of about 1.04; third regeneration III at a lambda value of about 1.06; fourth regeneration IV at a lambda value of about 1.08; and fifth regeneration V at a lambda value of about 1.1.

The uppermost representation of FIG. 4 shows the untreated nitrogen oxide NOx emissions of internal combustion engine 10 prior to particulate filter 24 or four-way catalytic converter 44. It is discernible that, at a slightly leaner than stoichiometric air/fuel ratio of about 1.02<λ<1.04, the nitrogen oxide emissions are particularly high, since especially unfavorable high-temperature reaction conditions are present in the combustion chamber, along with the lack of reducing co-agents that further a nitrogen oxide formation. As excess oxygen increases, the untreated emissions decrease significantly, as is discernible in regeneration IV and V. The carbon dioxide emissions also decrease noticeably since less energy is needed to heat particulate filter 24 or four-way catalytic converter 44, and, in addition, an increased dethrottling of the intake air is possible, which likewise has the effect of reducing [fuel] consumption.

The middle representation in FIG. 4 shows the nitrogen oxide emissions downstream of particulate filter 24 or of four-way catalytic converter 44. It is discernible here that, at higher excess oxygen of fourth regeneration IV and fifth regeneration V, these emissions are likewise lower. Moreover, the higher levels of excess oxygen shorten the regeneration of particulate filter 24 or of four-way catalytic converter 44 and the higher conversion rates associated therewith for oxidizing the soot particles.

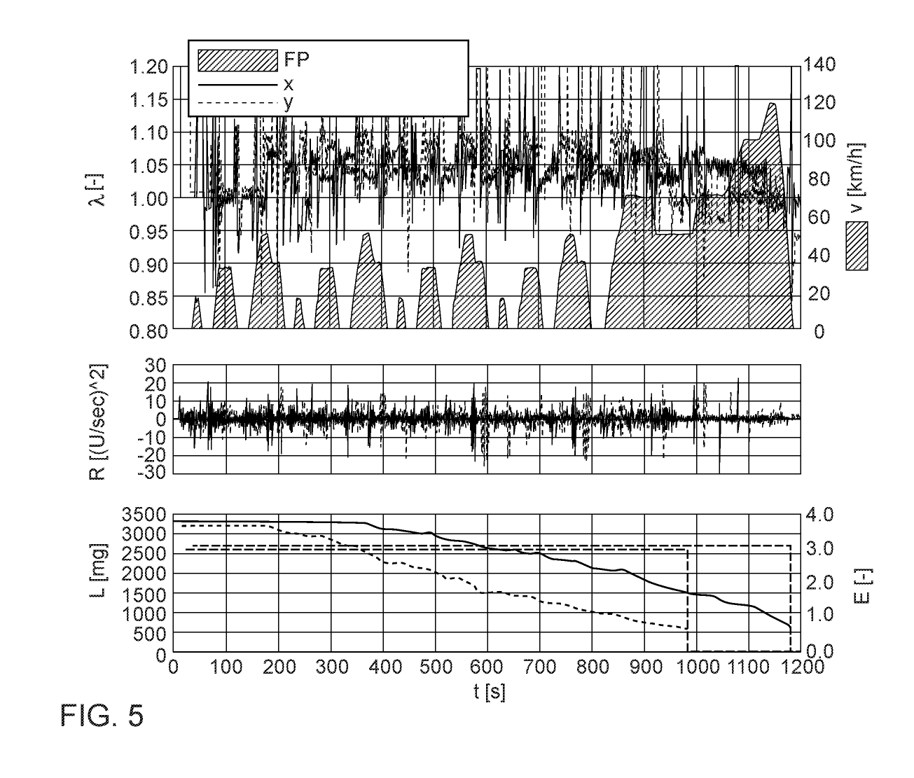

FIG. 5 shows the regeneration of a particulate filter 24 in a typical test cycle of the NEFZ. Air/fuel ratio λ, an index R for the running smoothness of internal combustion engine 10 and degree of saturation L of particulate filter 24 are shown as a function of time. In this context, in a first curve X, a regeneration in accordance with the related art is shown and, in comparison thereto, a regeneration using an inventive method for regenerating a particulate filter 24 where the regeneration is carried out with increased excess oxygen and a spark band ignition activated in parallel thereto. In addition, the top representation in FIG. 5 shows driving profile FP of NEFZ test cycle. As is discernible in the middle representation in FIG. 5, the inventive method does not lead to any degradation of running smoothness R of internal combustion engine 10. On the other hand, from the bottom representation in FIG. 5, it is inferable that particulate filter 24 is regenerated significantly faster and, at the same initial degree of saturation, the regeneration is completed appreciably earlier than in the related art method.

### LIST OF REFERENCE NUMERALS

10 internal combustion engine
12 spark plug
14 combustion chamber
16 exhaust
18 intake
20 exhaust system
22 exhaust-gas turbocharger
24 particulate filter
26 three-way catalytic converter
28 exhaust duct
30 first lambda probe
32 second lambda probe
34 first signal line
36 second signal line
38 sensor assembly
40 control unit
42 catalytically active coating
44 four-way catalytic converter
46 ignition distributor
48 NOx sensor
50 air supply system
52 air filter
54 throttle valve
56 compressor
58 fresh-air duct
E escalation level
FWC four-way catalytic converter
FP driving profile
L degree of saturation of the particulate filter/four-way particulate filter
NOx nitrogen oxide emissions
OPF gasoline particulate filter
OSC oxygen storage capacity
OSC_{P} oxygen storage capacity of the particulate filter
OSC_{TWC} oxygen storage capacity of the first three-way catalytic converter
R running smoothness
T temperature
TWC three-way catalytic converter
mg milligram
s second
v velocity
λ air/fuel ratio
λ₁ exhaust gas air ratio at the first lambda probe
λ₂ exhaust gas air ratio at the second lambda probe
λ_{S} setpoint value of the air/fuel ratio
I particulate filter regeneration at λ=1.02
II particulate filter regeneration at λ=1.04
III particulate filter regeneration at λ=1.06
IV particulate filter regeneration at λ=1.08
V particulate filter regeneration at λ=1.10
X initial situation
Y situation involving activated spark band ignition

1. A method for regenerating a particulate filter (24) or a four-way catalytic converter (44) in an exhaust system (20) of an internal combustion engine (10), comprising the following steps:
operating the internal combustion engine (10) at a stoichiometric air/fuel ratio (λ=1), the exhaust gas of the internal combustion engine (10) being directed through the exhaust system (20), and the soot particulate contained in the exhaust gas separating out at the surface of the particulate filter (24) or of the four-way catalytic converter (44);
initiating a regeneration of the particulate filter (24) or of the four-way catalytic converter (44) when the particulate filter (24) or the four-way catalytic converter (44) has reached or exceeded a stipulated saturation condition; and
regenerating the particulate filter (24), the internal combustion engine (10) being operated at a leaner than stoichiometric air/fuel ratio (λ>1) and, at the same time, the ignition energy, the duration of ignition, and/or the number of ignitions per combustion cycle being increased to ensure an ignition of the leaner than stoichiometric air/fuel ratio in the combustion chambers (14) of the internal combustion engine (10).

2. The method for regenerating a particulate filter (24) as recited in claim 1, wherein a multiple-spark ignition is used to ignite the combustion air mixture during regeneration of the particulate filter (24) or of the four-way catalytic converter (26).

3. The method for regenerating a particulate filter (24) as recited in claim 2, wherein the multiple-spark ignition takes place in the form of a spark band ignition.

4. The method for regenerating a particulate filter (24) as recited in claim 1, wherein the leaner than stoichiometric air/fuel ratio is selected during regeneration to be greater than 1.06.

5. The method for regenerating a particulate filter (24) as recited in claim 1, wherein the ignition energy, the duration of ignition, and/or the number of ignitions are/is reduced again following the complete regeneration of the particulate filter (24) or of the four-way catalytic converter (44).

6. The method as recited in claim 1, wherein the regeneration of the particulate filter (24) or of the four-way catalytic converter (44) is initiated at a degree of saturation of 2,500 mg or more.

7. The method as recited in claim 1, wherein an opening angle of a throttle valve (54) in an air supply system (50) of the internal combustion engine (10) is enlarged to regenerate the particulate filter (24) or the four-way catalytic converter (44).

8. The method as recited in claim 1, wherein a heating phase take place ahead of the regeneration phase of the particulate filter (24) or of the four-way catalytic converter (44), during ignition of the combustion air mixture; the ignition energy, the duration of ignition, and the number of ignitions being that of normal operation.

9. The method as recited in claim 1, wherein the ignition energy, duration of ignition or the number of ignitions are increased by a laser ignition.

10. The method as recited in claim 1, wherein a corona ignition is used to increase the ignition energy, the duration of ignition or the number of ignitions.

11. An internal combustion engine (10) having
at least one combustion chamber (14),
at least one ignition element (12) configured at the combustion chamber (14) for externally supplying ignition to a combustion air mixture introduced into the at least one combustion chamber (14),
an exhaust system (20) that is coupled to an exhaust (16) of the internal combustion engine (10),
at least one particulate filter (24) and a three-way catalytic converter (26) or a four-way catalytic converter (26) being disposed in the exhaust system (20),
a control unit (40) that is adapted for implementing a method according to claim 1 when a machine-readable program code is executed on the control unit (40).
